(19) United States
(12) Patent Application Publication
(10) Pub. No.: US 2009/0324992 A1
(43) Pub. Date: Dec. 31, 2009

(54) Metal clad laminate and manufacturing method thereof

(75) Inventor: Myung-Sam Kang, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/320,011

(22) Filed: Jan. 14, 2009

(30) Foreign Application Priority Data
Jun. 30, 2008 (KR) 10-2008-0062637

(51) Int. Cl. B32B 15/04; C25D 5/10; C25D 5/12; B32B 37/10; B32B 37/06

(52) U.S. Cl. 428/652; 428/656; 205/182; 205/181; 205/178; 156/151

(57) ABSTRACT

A metal clad laminate and a method of manufacturing the metal clad laminate are disclosed. The metal clad laminate can include a barrier layer made of a metallic material, a metal foil formed on one side of the barrier layer and coupled with the barrier layer by plating, and an insulator attached to the metal foil. By utilizing the metal clad laminate, the metal foil can be prevented from being perforated when processing a via hole using laser, so that a VOP structure may be implemented with a higher level of reliability.

### CROSS-REFERENCE TO RELATED APPLICATIONS

This application claims the benefit of Korean Patent Application No. 10-2008-0062637 filed with the Korean Intellectual Property Office on Jun. 30, 2008, the disclosure of which is incorporated herein by reference in its entirety.

### BACKGROUND

1. Technical Field

The present invention relates to a metal clad laminate and a method of manufacturing the metal clad laminate.

2. Description of the Related Art

In manufacturing current rigid boards, a copper clad laminate (CCL) may generally be used for the core material, where build-up layers can be stacked over the copper clad laminate to form a multi-layer board. Here, a copper clad laminate refers to a material in which copper foils 2, 3 are formed over both sides of an insulator 1 reinforced with glass fibers, etc., as illustrated in FIG. 1.

In accordance with the increasing demand for lighter and thinner portable electronic products that provide a greater number of functions, so also is the demand increasing for printed circuit boards that provide smaller thicknesses and higher densities.

Responding to such trends towards higher densities and higher levels of integration in a board, a structure has been proposed, as illustrated in FIG. 2, in which a via 6 that penetrates the insulator 1, on which a circuit pattern 4 is formed, is connected directly with a pad 6, and in which a solder ball (not shown) is coupled to this pad 5. This structure is referred to as a VOP (via on pad) structure.

In implementing this VOP structure, the process for forming a via hole 6a may be performed using a CO₂ laser drill, as illustrated in FIG. 3. However, in cases where the via hole 6a is formed in a board having thin copper foils 2, 3, such as in the case of a copper clad laminate, the CO₂ laser drill may cause the lower copper foil 3 to be perforated as well. Reference numeral 3a of FIG. 3 shows a lower copper foil 3 perforated by CO₂ laser.

### SUMMARY

An aspect of the invention provides a metal clad laminate and a method of manufacturing the metal clad laminate, in which a metal foil can be prevented from being perforated when processing a via hole using laser.

Another aspect of the invention provides a metal clad laminate that includes: a barrier layer made of a metallic material, a metal foil formed on one side of the barrier layer and coupled with the barrier layer by plating, and an insulator attached to the metal foil.

Here, the barrier layer can be made of a material containing at least one of nickel (Ni), aluminum (Al), and chromium (Cr), while the metal foil can be made of a material containing copper (Cu).

A metal layer can be formed on the other side of the barrier layer, where the barrier layer can be formed on the metal layer by plating. In this case, the barrier layer can be made of a material containing at least one of nickel (Ni), aluminum (Al), and chromium (Cr), and the metal foil and the metal layer can be made of materials containing copper (Cu).

Yet another aspect of the invention provides a method of manufacturing a metal clad laminate that includes: forming a barrier layer over one side of a metal layer by performing plating, forming a metal foil over one side of the barrier layer by performing plating, and attaching an insulator to one side of the metal foil.

The barrier layer can be made of a material containing at least one of nickel (Ni), aluminum (Al), and chromium (Cr), and the metal foil and the metal layer can be made of materials containing copper (Cu).

The attaching operation can be performed by hot pressing the insulator in a semi-cured (B-stage) state with a metal foil.

Still another aspect of the invention provides a method of manufacturing a metal clad laminate that includes: attaching a metal foil to one or either side of an insulator, and forming a barrier layer over the metal foil by way of electroplating.

Here, the metal foil can be made of a material containing copper (Cu), and the barrier layer can be made of a material containing at least one of nickel (Ni), aluminum (Al), and chromium (Cr).

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross sectional view illustrating a metal clad laminate according to the related art.

FIG. 2 is a cross sectional view illustrating a VOP (via on pad) structure.

FIG. 3 is a cross sectional view illustrating the processing of a via hole in a metal clad laminate according to the related art.

FIG. 4 is a cross sectional view illustrating a first disclosed embodiment of a metal clad laminate according to an aspect of the invention.

FIG. 5 is a cross sectional view illustrating a second disclosed embodiment of a metal clad laminate according to an aspect of the invention.

FIG. 6 is a flowchart illustrating a first disclosed embodiment of a method of manufacturing a metal clad laminate according to another aspect of the invention.

FIG. 7 is a flowchart illustrating a second disclosed embodiment of a method of manufacturing a metal clad laminate according to another aspect of the invention.

FIG. 8 through FIG. 16 and FIG. 17 through FIG. 24 are cross sectional views representing flow diagrams for methods of forming a VOP structure using a metal clad laminate according to an aspect of the invention.

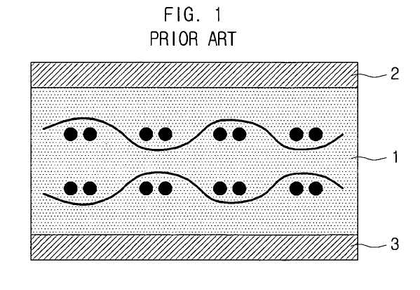

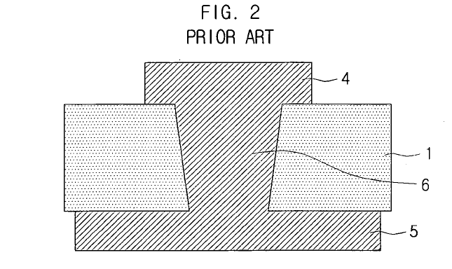

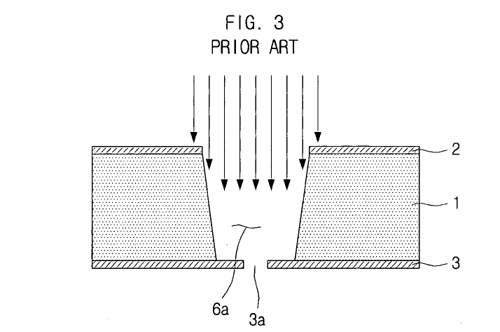

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The metal clad laminate and method of manufacturing the metal clad laminate according to certain embodiments of the invention will be described below in more detail with reference to the accompanying drawings. Those components that are the same or are in correspondence are rendered the same reference numeral regardless of the figure number, and redundant explanations are omitted.

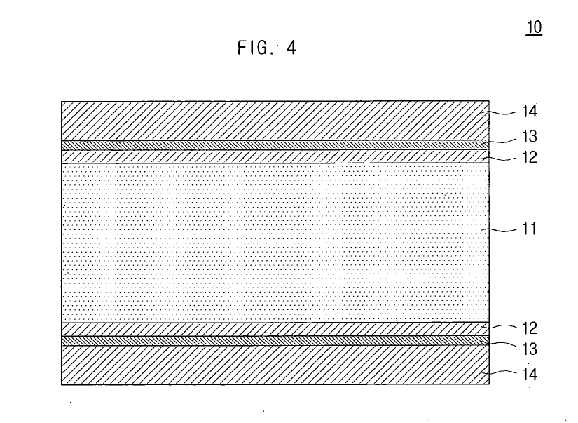

FIG. 4 is a cross sectional view illustrating a first disclosed embodiment of a metal clad laminate according to an aspect of the invention. In FIG. 4, there are illustrated a metal clad laminate 10, an insulator 11, metal foils 12, barrier layers 13, and metal layers 14.

A metal clad laminate 10 according to this embodiment can be structured to have a metal foil 12, a barrier layer 13, and a metal layer 14 formed in order on either side of an insulator 11.

The insulator 11 may serve to electronically separate the circuit patterns formed on both sides by patterning. The insulator 11 can include glass fibers impregnated with epoxy resin. Other insulating materials may also be used for the insulator 11.

The metal foil 12 facing the insulator 11 can be formed with a maximum thickness of about 2 μm, where the metal foil can be made mainly of copper (Cu).

The barrier layer 13 formed over the metal foil 12 can be formed with a thickness of about 4 μm, where the barrier layer can be made of a different material from that of the metal foil 12. In cases where the metal foil 12 is made of copper as described above, the barrier layer 13 can be made of a material containing at least one of nickel (Ni), aluminum (Al), and chromium (Cr). For example, the barrier layer 13 can be made of a material containing nickel sulfonate.

The metal layer 14 formed over the barrier layer 13 can be formed with a thickness of about 12 μm or more, where the metal layer 14 can be made of a different material from that of the barrier layer 13. For instance, in cases where the barrier layer 13 is made of a material containing nickel sulfonate as mentioned above, the metal layer 14 can be made of a material containing copper.

The metal foil 12, barrier layer 13, and metal layer 14 mentioned above can be coupled together by plating. For example, the barrier layer 13 can be formed on the metal layer 14 by electroplating, and the metal foil 12 can be formed on the barrier layer 13 by electrolytic plating.

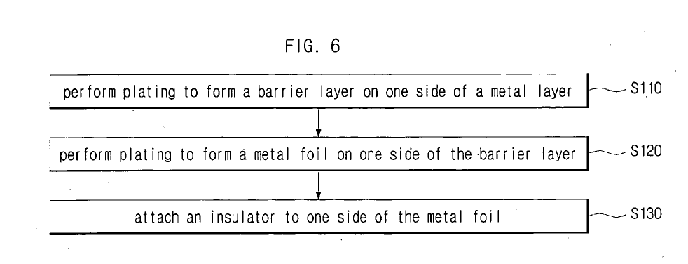

That is, plating can be performed to form the barrier layer 13 on one side of the metal layer 14 by plating (S110 of FIG. 6), after which plating can be performed again to form the metal foil 12 on one side of the barrier layer 13 (S120 of FIG. 6), and then the insulator 11 can be attached to one side of the metal foil 12 (S130 of FIG. 6), to produce a metal clad laminate 10 as presented in the embodiment.

Of course, the opposite is also possible. That is, after plating the barrier layer 13 on the metal foil 12, the metal layer 14 can again be plated on the barrier layer 13.

In attaching the metal foil 12 and the insulator 11 together, a method can be used of compressing a semi-cured (B-stage) insulator 11 onto the metal foil 12 under a high-temperature, high-pressure environment.

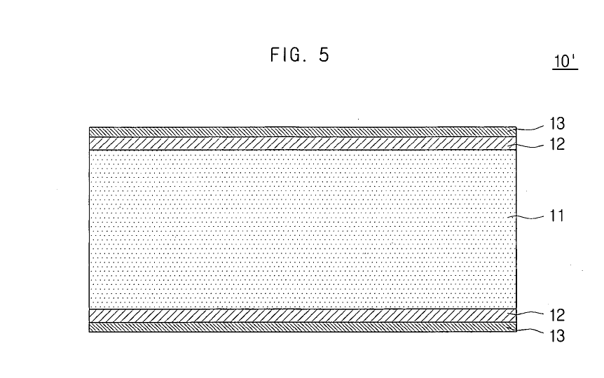

Further, as a modified version of the metal clad laminate 10 disclosed in the embodiment described above, a metal clad laminate 10′ may also be utilized, which is structured as shown in FIG. 5.

FIG. 5 is a cross sectional view illustrating a second disclosed embodiment of a metal clad laminate according to an aspect of the invention, where FIG. 5 illustrates a metal clad laminate 10, an insulator 11, metal foils 12, and barrier layers 13.

As illustrated in FIG. 5, the metal layers 14 situated on the outermost layers of the structure described in the first disclosed embodiment can be excluded in the structure of the metal clad laminate 10′ according to this embodiment.

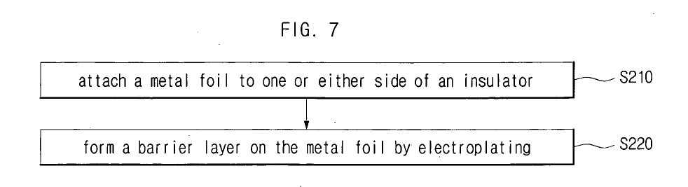

To manufacture this type of metal clad laminate 10′, a method can be used of attaching the metal foil 12 onto one side or both sides of the insulator 11 (S210 of FIG. 7), and afterwards forming the barrier layer 13 on the metal foil 12 by electroplating (S220 of FIG. 7).

A method of attaching the metal foil 12 to the insulator 11 can include pressing a carrier (not illustrated), to which the metal foil 12 is attached, onto the insulator 11, and then removing the carrier (not illustrated). Furthermore, it is to be appreciated that the metal foil 12 can also be formed directly on the insulator 11, for example, using a method of electroplating.

A description will now be provided on a method of manufacturing a printed circuit board, in particular, a VOP structure, using a metal clad laminate having a structure set forth above.

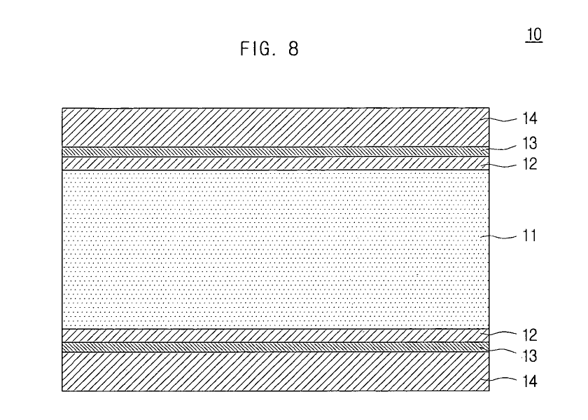

FIG. 8 through FIG. 16 and FIG. 17 through FIG. 24 are cross sectional views representing flow diagrams for methods of forming a VOP structure using a metal clad laminate according to an aspect of the invention. According to FIG. 8 through FIG. 24, a metal clad laminate 10, an insulator 11, metal foils 12, barrier layers 13, metal layers 14, a via 15, a via hole 15a, seed layers 16, plating resists 17, circuit patterns 18, and a pad 19 are illustrated.

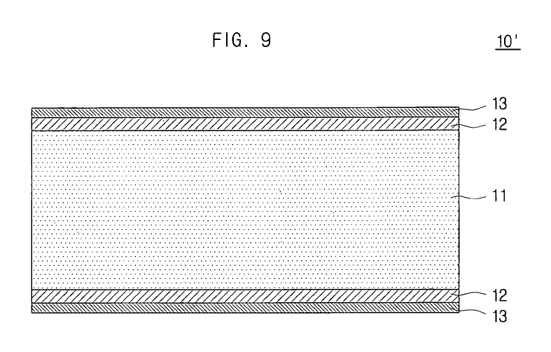

First of all, a metal clad laminate 10 having a structure based on the first disclosed embodiment can be prepared, as illustrated in FIG. 8, and then the metal layers 14 formed on the outermost layers can be removed, as illustrated in FIG. 9. A method of removing the metal layers 14 can include chemical etching.

As described above, the metal layers 14 and the barrier layers 13 can be made of different materials, so that the barrier layers 13 may not be harmed in the process of removing the metal layers 14 using an etchant.

Furthermore, as described above, the structure of a metal clad laminate 10′ according to the second disclosed embodiment is similar to the structure of a metal clad laminate 10 according to the first disclosed embodiment with the metal layers 14 removed. Thus, one approach may include using the metal clad laminate 10′ according to the second disclosed embodiment from the beginning, instead of preparing the metal clad laminate 10 according to the first embodiment as mentioned above and then removing the metal layers 14.

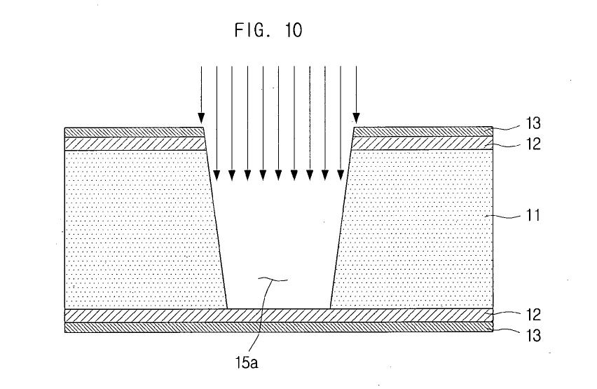

Afterwards, a via hole 15a can be processed using CO₂ laser, as illustrated in FIG. 10. In a metal clad laminate 10 according to this embodiment, a barrier layer 13 can be formed under the lower metal foil 12 to reinforce the metal foil 12, whereby damage to the lower metal foil 12 can be minimized during the process of forming the via hole 15a using CO₂ laser.

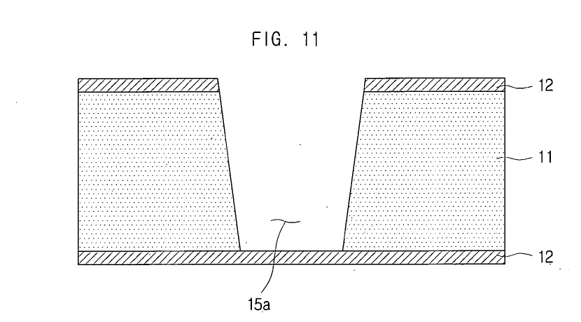

Then, the barrier layers 13 can be removed, as illustrated in FIG. 11. The method of removing the barrier layers 13 can employ chemical etching. Since the barrier layers 13 and metal foils 12 may be made of different materials, as described above, the metal foils 12 may not be harmed during the process of removing the barrier layer 13 using an etchant for eliminating the barrier layer 13.

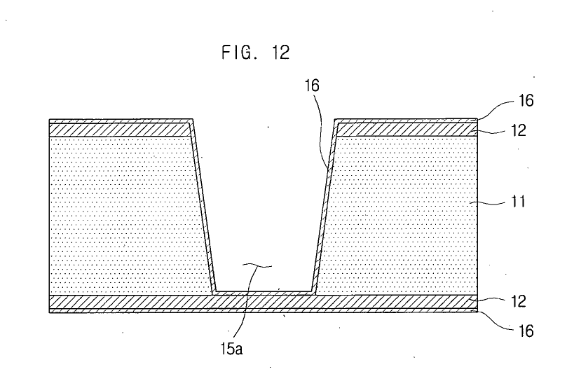

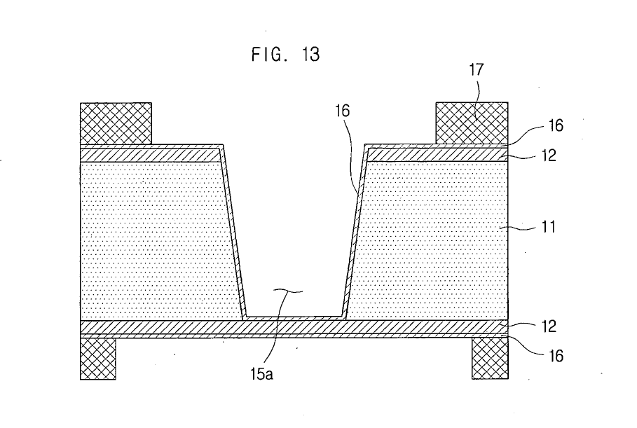

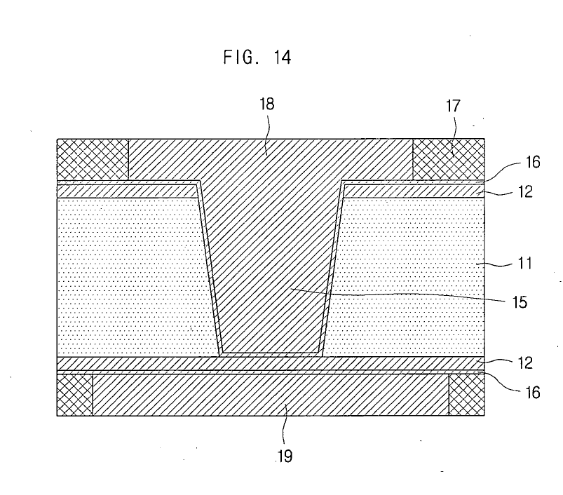

Afterwards, seed layers 16 can be formed on the surfaces of the metal foils 12 and on the inner wall of the via hole 15a, as shown in FIG. 12, and plating resists 17 can be formed, as shown in FIG. 13. Then, circuit patterns 18 and a pad 19 can be formed using electroplating, as illustrated in FIG. 14.

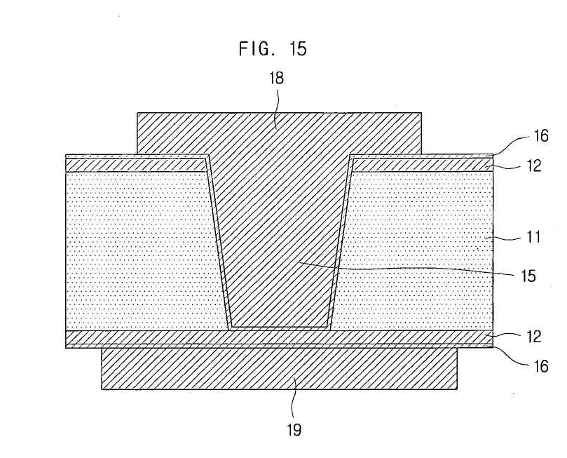

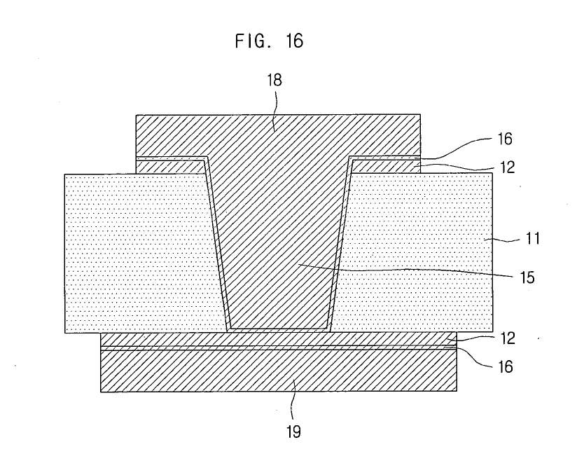

Next, the plating resists 17 can be removed, as illustrated in FIG. 15, and parts of the seed layers 16 and metal foils 12 can be removed by flash etching, as illustrated in FIG. 16, to complete the VOP structure.

In the description provided above, a method of forming the seed layers 16 has been disclosed, in which the processing of the via hole 15a using CO₂ laser is followed by removing the barrier layers 13 and then forming the seed layers 16. It is to be appreciated, however, that the seed layers 16 can also be formed without removing the barrier layers 13.

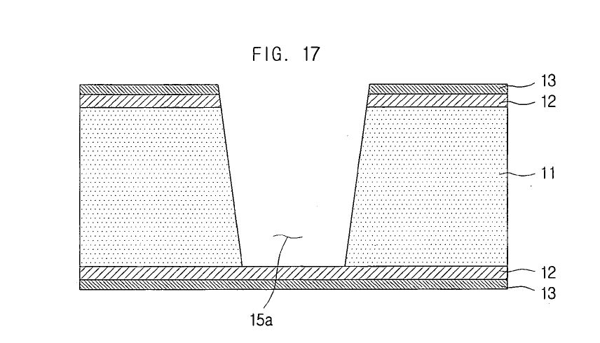

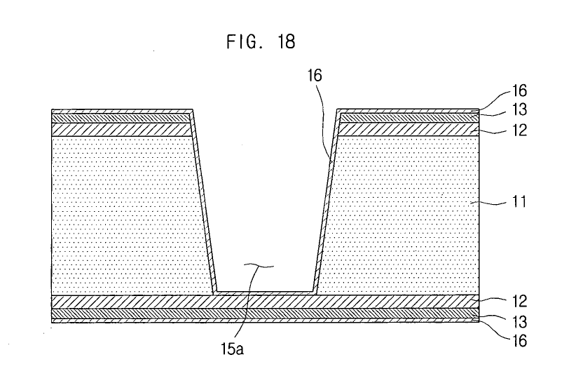

That is, after forming the via hole 15a, as illustrated in FIG. 17, the seed layers 16 can be formed on the surfaces of the barrier layers 13 and on the inner wall of the via hole 15a, as shown in FIG. 18.

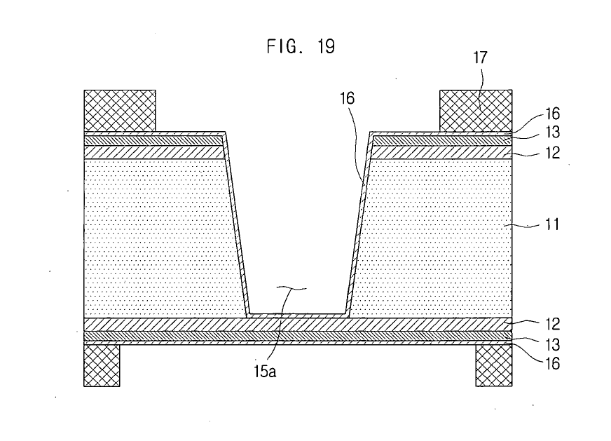

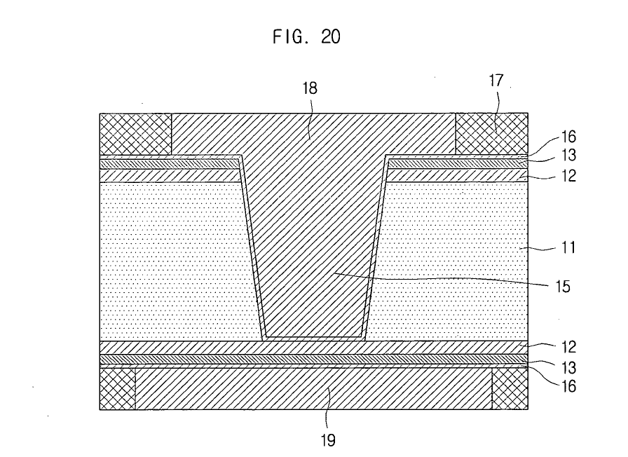

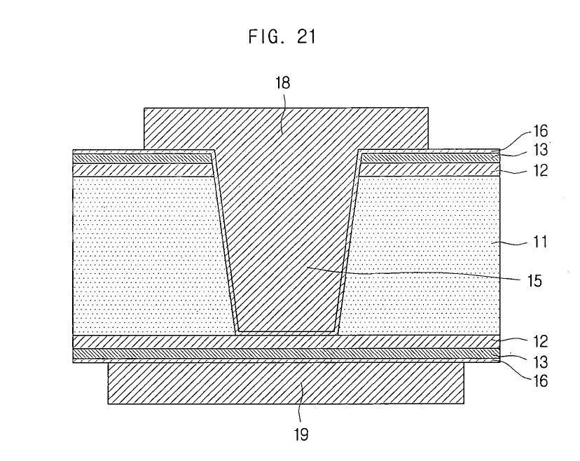

Then, plating resists 17 can be formed on the seed layers 16, as illustrated in FIG. 19, and an electroplating process can be performed, as shown in FIG. 20, after which the plating resists 17 can be removed, as illustrated in FIG. 21.

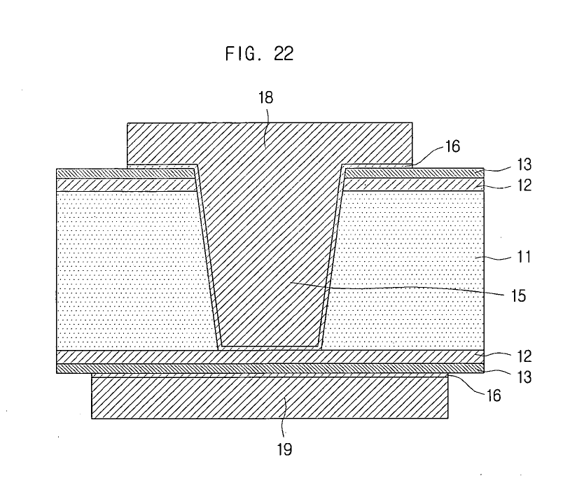

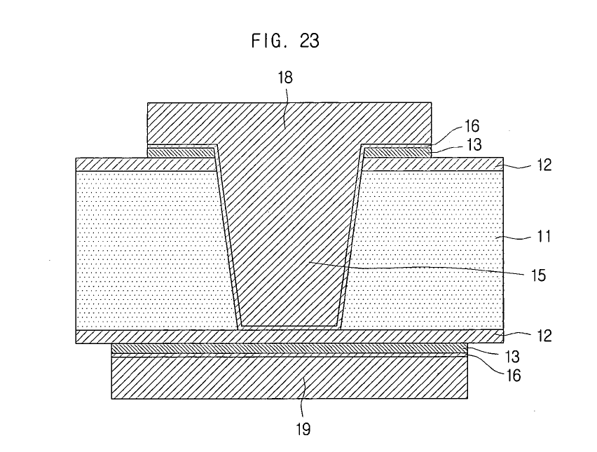

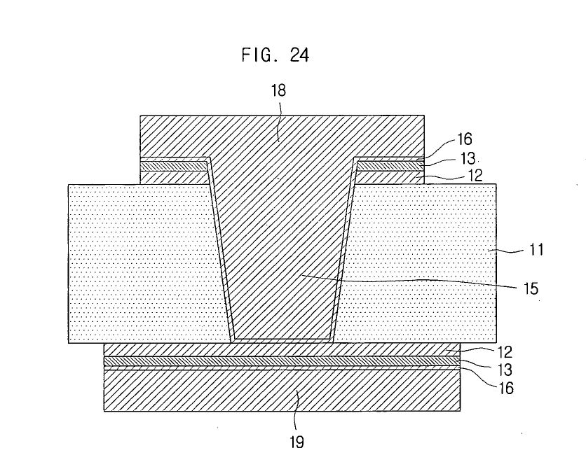

In this case, since the barrier layers 13 may remain, the manufacture of the VOP structure can include removing the seed layers 16 using flash etching, as illustrated in FIG. 22, removing portions of the barrier layers 13, as shown in FIG. 23, and finally removing portions of the metal layers 14, as shown in FIG. 24.

According to certain aspects of the invention as set forth above, the metal clad laminate can be produced without perforation in the metal foil during the processing of the via hole using laser.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. A metal clad laminate comprising:
a barrier layer made of a metallic material;
a metal foil formed on one side of the barrier layer, the metal foil coupled with the barrier layer by plating; and
an insulator attached to the metal foil.

2. The metal clad laminate of claim 1, wherein the barrier layer is made of a material containing at least one of nickel (Ni), aluminum (Al), and chromium (Cr), and the metal foil is made of a material containing copper (Cu).

3. The metal clad laminate of claim 1, further comprising:
a metal layer formed on the other side of the barrier layer,
wherein the barrier layer is formed on the metal layer by plating.

4. The metal clad laminate of claim 3, wherein the barrier layer is made of a material containing at least one of nickel (Ni), aluminum (Al), and chromium (Cr), and the metal foil and the metal layer are made of materials containing copper (Cu).

5. A method of manufacturing a metal clad laminate, the method comprising:
forming a barrier layer over one side of a metal layer by performing plating;
forming a metal foil over one side of the barrier layer by performing plating; and
attaching an insulator to one side of the metal foil.

6. The method of claim 5, wherein the barrier layer is made of a material containing at least one of nickel (Ni), aluminum (Al), and chromium (Cr), and the metal foil and the metal layer are made of materials containing copper (Cu).

7. The method of claim 5, wherein the insulator is in a semi-cured (B-stage) state, and
the attaching is performed by way of hot pressing.

8. A method of manufacturing a metal clad laminate, the method comprising:
attaching a metal foil to one or either side of an insulator; and
forming a barrier layer over the metal foil by way of electroplating.

9. The method of claim 8, wherein the metal foil is made of a material containing copper (Cu), and
the barrier layer is made of a material containing at least one of nickel (Ni), aluminum (Al), and chromium (Cr).
